(19) United States
(12) Patent Application Publication
(10) Pub. No.: US 2024/0163116 A1
(43) Pub. Date: May 16, 2024

(54) METHOD FOR IMPLEMENTING MUTUAL AUTHENTICATION PROTOCOL BASED ON RADIO FREQUENCY FINGERPRINT AND FUZZY EXTRACTOR

(71) Applicant: Shanghai Jiao Tong University, Shanghai (CN)

(72) Inventors: Cunqing HUA, shanghai (CN); Chengchen Zhu, Shanghai (CN); Jianan Hong, Shanghai (CN); Yue Wu, Shanghai (CN)

(21) Appl. No.: 18/365,967

(22) Filed: Aug. 4, 2023

(30) Foreign Application Priority Data
Nov. 15, 2022 (CN) 202211431564.1

(51) Int. Cl. H04L 9/32; H04L 9/08; H04L 9/30

(52) U.S. Cl. CPC H04L 9/3273; H04L 9/0869; H04L 9/3073

(57) ABSTRACT

A mutual authentication protocol based on radio frequency (RF) fingerprint and fuzzy extractor is provided. Two kinds of nodes in the protocol are denoted by authenticator and verifier respectively. In the registration phase, the verifier sends a registration request to the verifier, the verifier receives its RF fingerprint and uses the fuzzy extractor to process it. After storing the help string P related to the verifier, the key generated by R is returned to the verifier, and the verifier stores the key after receiving it. In the authentication phase, the verifier sends an encrypted message containing the challenge value to the verifier. After receiving it, the verifier recovers the key needed for decryption through the fuzzy extractor using the extracted RF fingerprint and the previously stored P value, and returns a reply message to the verifier to achieve the final two-way authentication effect.

### CROSS-REFERENCE TO RELATED APPLICATIONS

The subject application claims priority on Chinese Patent Application No. 202211431564.1 filed on Nov. 15, 2022. The contents and subject matters of the Chinese priority application is incorporated herein by reference.

### TECHNICAL FIELD

The present invention relates to wireless device authentication, in particular, a method for implementing mutual authentication protocol based on radio frequency (RF) fingerprint and fuzzy extractor.

### BACKGROUND ART

With the rapid development of 5G technology and Internet of Things in recent years, mobile phone users and Internet of Things devices are on the rise. According to the 2022 Statistical Report on the Development of China's Internet Network, in the information and communication industry, as of December 2021, a total of 1.425 million 5G base stations had been built and opened, and the number of new 5G base stations reached 654,000 throughout the year. The number of industrial internet platforms with national influence has exceeded 150, and the total number of access devices has exceeded 76 million. More than 2,000 “5G+Industrial Internet” projects are under construction nationwide. The integration and innovative application of industrial Internet and 5G in key industries of the national economy is accelerating.

The data show that China's information construction has made great results, the number of users is increasing, people are more accustomed to the internet into our lives. At the same time, it also brings great challenges to the security of authentication in related fields. Generally speaking, traditional authentication protocols rely on key technology and handshake protocol, which brings a lot of risks. For example, in a man-in-the-middle attack, the attacker can create separate connections with both parties and exchange the received data, making both parties think they are communicating over a private connection. In addition, there will be ALTER attack, forgery attack, and other attack methods.

Fuzzy extractor technology has attracted more and more attention in the field of cyberspace security in recent years because it can solve the problem of key storage in cryptography. Combined with the characteristics of biometrics, it provides a new idea for more secure authentication protocols. Fuzzy extractor can generate key from one fingerprint information and reproduce the previous key when the subsequent fingerprint information of the same source arrives. So it is helpful to solve the problem of key storage for the authenticator, yet it loses the security of fingerprint identification to some extent.

Radio frequency fingerprinting technology is a technology that has emerged with the development of AI technology in recent years. It uses the physical characteristics of the sending device to distinguish different devices, rather than simply based on the signaling content, which brings higher security than the traditional authentication mode. According to its characteristics, radio frequency (RF) fingerprints are very suitable for verification related work.

### SUMMARY OF THE INVENTION

To solve the problems of the current technology, the present invention provides a mutual authentication protocol based on RF fingerprint and fuzzy extractor for a communication process with two nodes, which comprises the following steps:

Step 1. In the registration phase, the authenticator sends a registration request to the verifier, the verifier receives its RF fingerprint and uses the fuzzy extractor to process it. After storing the help string P related to the authenticator, the key generated by R is returned to the authenticator, and the authenticator receives it and stores it.

Step 2. In the authentication phase, the authenticator sends an encrypted message containing the challenge value to the verifier. After receiving it, the verifier recovers the key needed for decryption through the fuzzy extractor using the extracted RF fingerprint and the previously stored P value, and returns a reply message to the authenticator to achieve the final mutual authentication.

In step 1, after receiving the registration request, the verifier uses the fuzzy extractor to generate R and the help string P. If the asymmetric key generated by R is used, the specific steps are as follows:

(2-1) After receiving the registration request from the authenticator, the verifier first needs to obtain the output result of the RF fingerprint and quantize it to obtain the fingerprint data w.

(2-2) For the processed fingerprint data w, we process it as the input of the fuzzy extractor and execute the generating function:

R,P=Generate(w),

wherein R is a secret value that can be used to generate a public-private key pair, namely the public key pk and the private key sk. P is a help value that is used as input in the reproduction function to output the same R value along with the fingerprint data. Here, the verifier first needs to store the authenticator information and its corresponding P value, and then returns the public key pk to the authenticator. The authenticator receives and stores the public key pk corresponding to the verifier.

In step 2, the challenge-response mechanism is used and the paste extractor is used to execute the regeneration algorithm to obtain the same R value as the registration phase for mutual authentication. If the asymmetric key generated by R is used, the specific steps are as follows:

(3-1) The authenticator first uses the random number generation function to obtain a challenge value ch.

(3-2) The authenticator finds the public key pk of the verifier in its own node, encrypts the ch value with the public key pk, and sends it to the verifier with the following message:

m=encrypt(ch,pk)+authenticator+hash(ch).

(3-3) After receiving the message from the authenticator, the verifier searches for P related to the authenticator in its own node, and at the same time gets the output result of the RF fingerprint and quantifies it to obtain the fingerprint data w′.

(3-4) The verifier takes the fingerprint data w′ and P as the input of the fuzzy extractor, performs the regeneration algorithm, and obtains the same R as in the registration phase:

R=Reproduce(w′,P).

(3-5) The verifier generates the same public and private key pair according to R to obtain the private key sk; The verifier uses the private key sk to decrypt the received message and obtain the ch value:

ch=decrypt(m,sk),

wherein if the decryption is successful and the hash value is the same, the verifier has successfully authenticated the identity of the verifier.

(3-6) The verifier signs ch with the private key sk and sends the message to the verifier. Upon receipt, the verifier verifies using the public key pk, and if the verification passes, the verifier authenticates the identity of the verifier.

In step 1, after receiving the registration request, the verifier uses the fuzzy extractor to generate R and help string P. If the symmetric key is generated by using R, the specific steps are as follows:

(4-1) After receiving the registration request from the authenticator, the verifier first needs to obtain the output result of the RF fingerprint and quantize it.

(4-2) For the processed fingerprint data w, we process it as the input of the fuzzy extractor and execute the generating function:

R,P=Generate(w),

wherein R is a secret value and some algorithm can be used to generate a symmetric key K. P is a help value that is used as input in the reproduction function to output the same R value along with the fingerprint data. Here, the verifier first needs to store the verifier information and its corresponding P value, and then returns the symmetric key K to the verifier, and the verifier stores the verifier corresponding to K after receiving it. Here, we consider that the channel during registration is secure.

In the described step 2, the challenge-response mechanism is used and the paste extractor is used to execute the regeneration algorithm to obtain the same R value as the registration phase for mutual authentication. If the symmetric key is generated by using R, the specific steps are as follows:

(5-1) The verifier first uses the random number generation function to obtain a challenge value ch.

(5-2) The verifier finds the symmetric key K of the verifier in its own node, encrypts the ch value with K, generates a hash value and sends it to the verifier. The message content is as follows:

m=encrypt(ch,K)+authenticator+hash(ch).

(5-3) After receiving the message from the authenticator, the verifier searches for P related to the authenticator in its own node, and at the same time gets the output result of the RF fingerprint and quantifies it.

(5-4) The verifier takes the fingerprint data w′and P as the input of the fuzzy extractor and executes the reproduction algorithm to obtain the same R as in the registration phase:

R=Reproduce(w′,P).

(5-5) The verifier generates the same symmetric key K according to R. The verifier uses K to decrypt the received message and obtain the ch value:

ch=decrypt(m,K),

wherein if the hash value is successfully decrypted and verified, the verifier has successfully authenticated the identity of the verifier.

(5-6) The verifier uses the hash function with the key K to sign the ch and sends the message to the verifier. After receiving it, the verifier verifies using K. If the verification passes, the verifier authenticates the identity of the verifier.

Compared with the current technology, the technical effects of the present invention are as follows. Compared with the traditional authentication protocol, the security of the key and the reliability of the protocol are greatly improved.

Firstly, using the technology of combining fuzzy extractor and RF fingerprint, it realizes the secure storage of the key and a fast mutual authentication process. For the traditional authentication method, since its premise is the security of the key, it needs extra overhead to ensure that the key is not leaked, so as to ensure the security of the whole protocol process.

Both parties of the invention do not need to save the vital private key, only need to save some extra help information, which saves a lot of resources and improves the security of the protocol itself.

For the attacker, because of the use of RF fingerprints, if he does not have access to the original fingerprint party's device, it is difficult for him to forge the correct fingerprint information for authentication. At the same time, the data stored in the two sides has nothing to do with the information of the two sides themselves, and if the attacker knows it, it will not cause a very serious impact.

### BRIEF DESCRIPTION OF THE DRAWINGS

FIG. 1 shows the registration phase in the present invention.

FIG. 2 shows the authentication phase in the present invention.

FIG. 3 is a flowchart showing the use of asymmetric keys in the first embodiment of the present invention.

FIG. 4 is the process diagram showing the fingerprint data quantization in the present invention.

FIG. 5 is a flowchart showing the second embodiment of the present invention using a symmetric key.

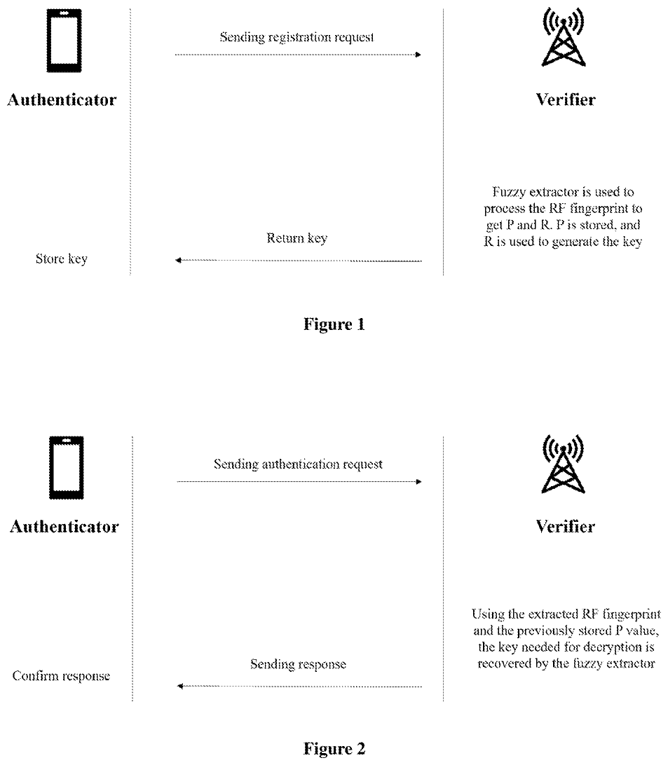

### DETAILED DESCRIPTION OF THE INVENTION AND EMBODIMENTS

The present invention shall be further explained in conjunction with the accompanying drawings and embodiments, but the scope of protection of the present invention shall not be limited thereby.

For both communication parties, the authenticator can be a small electronic device, such as an IoT device, while the authenticator can be a larger server or gateway, executing the entire protocol process between the two. Because this agreement has two methods: symmetric key and asymmetric key, they are explained separately.

The present invention provides a method for implementing bidirectional authentication based on RF fingerprint and fuzzy extractor using two types of nodes denoted by an authenticator and a verifier, respectively, comprising (1) in a registration phase, sending a registration request from a radio frequency (RF) fingerprint based authenticator to a verifier, extracting an RF fingerprint feature based on the registration request, processing the RF fingerprint feature through a fuzzy extractor, and generating a help string P related to the authenticator and a string R used for generating a key in the verifier, storing the help string P in the verifier and sending the string R from the verifier to the authenticator, and storing the string R in the authenticator; and (2) in an authentication phase, using a random number generation function to generate a challenge value ch and using the key generated by the string R to encrypt a message in the authenticator, and sending the message from the authenticator to the verifier, using the RF fingerprint features and the help string P obtained in the registration phase to recover the same string R as the registration phase and the string R used for generating the key through the fuzzy extractor in the verifier, generating the key needed for decryption by using the string R, decrypting the message received, and returning a reply message from the verifier to the authenticator, verifying the reply message by the authenticator, and authenticating an identity of the verifier after passing the verification, and completing a process of mutual authentication.

The present invention further provides that the key generated by string R may be an asymmetric key prepared by the following steps: (1) in the registration phase, conducting a quantitative processing by the verifier to obtain a fingerprint data w after receiving the registration request sent by the authenticator and extracting the RF fingerprint features, using the fingerprint data w as an input for the fuzzy extractor and executing a generation function: R,P=Generate(w), wherein the string R is used to generate a public-private key pair of the asymmetric key comprising a public key pk and a private key sk, P is the help string related to the authenticator and used as an input for the generation function and outputs a same string R value together with the fingerprint data w, storing in the verifier the help string P corresponding to the authenticator's information and returning the public key pk to the authenticator, corresponding the verifier to the public key pk and storing the public key pk in the authenticator; (2) in the authentication phase, using a random number generation function to obtain a challenge value ch in the authenticator, searching the public key pk related to the verifier by the authenticator within authenticator's own node, encrypting the challenge ch value using the public key pk, and sending an encrypted message to the corresponding verifier with the following content: m=encrypt(ch,pk)+authenticator+hash(ch), searching for the help string P related to the authenticator in the verifier within the verifier's own node, and quantifying the RF fingerprint features obtained in the registration phase to obtain a fingerprint data w′, using the fingerprint data w′ and P as input to the fuzzy extractor, and executing a regeneration algorithm to recover the same string R as in the registration phase: R=Reproduce(w′,P), generating by the verifier the same public and private key pair based on the string R comprising the private key sk, and using the private key sk to decrypt the received message and obtain a ch value: ch=decrypt(m,sk), successfully authenticating the identity of the verifier after the decryption is successful and the hash value is the same, using the private key sk to sign ch and sending the reply message from the verifier to the authenticator, using the public key pk to verify the reply message by the authenticator, and authenticating the identity of the verifier and completing the process of mutual authentication by the authenticator.

The present invention further provides that the key generated by the string R may be a symmetric key prepared by the following steps: (1) in the registration phase, after receiving the registration request from the authenticator, the verifier extracting the RF fingerprint features and quantifying the extracted RF fingerprint features to obtain a fingerprint data w, using the fingerprint data w as an input of the fuzzy extractor and executing a generation function as follows: R,P=Generate(w), wherein the string R is used to generate a symmetric key K, P is the help string related to the authenticator and used as an input of the generation function and outputs the same string R value together with the fingerprint data w, the verifier storing the help string P corresponding to the authenticator's information and returning the symmetric key K to the authenticator, corresponding the verifier with the symmetric key K and storing the symmetric K by the authenticator; and (2) in the authentication phase, using a random number generation function to obtain a challenge value ch by the authenticator, the authenticator looking up the symmetric key K corresponding to the verifier in the authenticator's own node, encrypting the challenge ch value with the symmetric key K, and sends an authentication request to the corresponding verifier with the following content: m=encrypt(ch,K)+authenticator+hash(ch), the verifier searching for the help string P related to the authenticator in the verifier's own node, and quantizing the RF fingerprint features obtained in the registration phase to obtain a fingerprint data w′, using the fingerprint data w′ and P as input to the fuzzy extractor, and executing a regeneration algorithm to recover the same string R as in the registration phase: R=Reproduce(w′,P), the verifier generating the same symmetric key K according to the string R, and using the symmetric key K to decrypt the received message and obtain a ch value: ch=decrypt(m,K), the authenticator successfully authenticating the identity of the verifier after the hash value is successfully decrypted and verified, the verifier using the symmetric key K to sign the ch and sending the reply message to the authenticator, after receiving the reply message, the authenticator using the symmetric key K to verify, and the verifier authenticating the identity of the authenticator after the verification passes, and completing the process of mutual authentication.

### Example 1

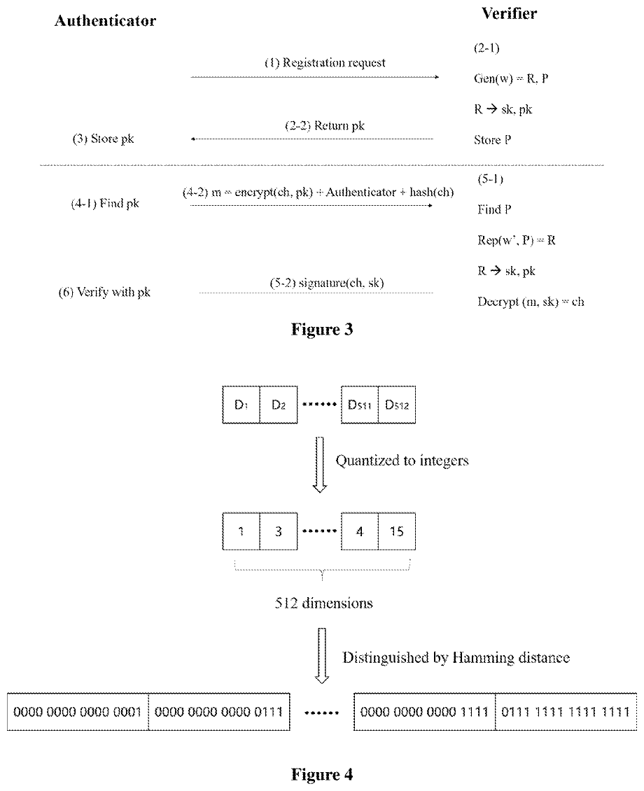

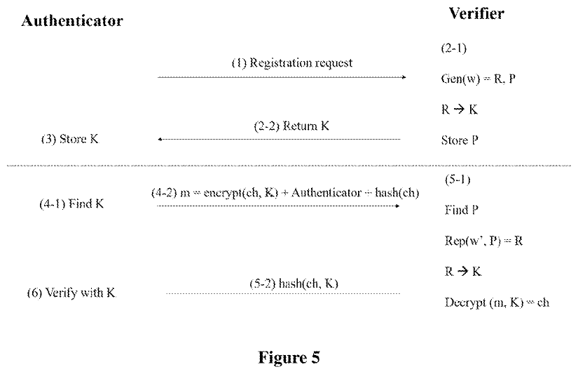

The authentication process of the asymmetric key method is as follows, as shown in FIG. 3:

Step 1: The authenticator sends a registration request to the verifier.

Step 2: After receiving the registration request, the verifier uses a fuzzy extractor to generate a public private key pair and a help string P, as follows:

As shown in FIG. 4, after receiving the registration request sent by the authenticator, the verifier first needs to obtain the output result of the RF fingerprint and quantify it. Here, we use a 512 dimensional RF fingerprint output as an example, where the output of each dimension is within a certain range, i.e. Dₘᵢₙ˜Dₘₐₓ. Therefore, we can quantify each dimension, such as mapping it to the range of 0-16, as follows:

$$\\ {D}_{quatization} = [ 16 \times \frac{D - {D}_{min}}{{D}_{max} - {D}_{min}} ] .$$

In addition, the fuzzy extractor used is distinguished by the input Hamming distance, and cannot directly use the data obtained above, requiring special processing. Taking the obtained number 2 as an example, it needs to be converted into a data format of 0000 0000 0000 0011, which means that in a 16 bit binary data, there are as many is as the original data. Finally, the binary data obtained from each dimension is concatenated to obtain the final fingerprint data w. For the processed fingerprint data w, process it as input to the fuzzy extractor and execute the generation function: R, P=Generate(w), wherein R is a secret value that can be used to generate a public-private key pair, namely the public key pk and the private key sk. P is a help value that is used as input in the reproduction function to output the same R value along with the fingerprint data. Here, the verifier first needs to store the verifier information and the corresponding P value, and then returns the public key pk to the verifier.

Step 3: After the authenticator receives the public key pk, it stores the corresponding key and completes the registration process.

Step 4: The authenticator initiates the authentication request as follows:

The authenticator first utilizes the random number generation function to obtain a challenge value ch. At the same time, the verifier looks up the public key pk related to the verifier in its own node and sends the encrypted message to the other party, the specific content of the message is as follows:

m=encrypt(ch,pk)+authenticator+hash(ch).

Step 5: After receiving the authentication request, the verifier uses the fuzzy extractor to execute the regeneration algorithm to obtain the same R value as the registration phase and recover the key. The specific process is as follows:

After receiving the message from the authenticator, the verifier looks for the P associated with the authenticator in its own node, and at the same time gets the output result of the RF fingerprint and quantifies it as in the registration phase. The verifier takes the fingerprint data w′and P as the input of the fuzzy extractor and performs the reproduction algorithm to obtain the same R as in the registration phase:

R=Reproduce(w′,P).

The verifier generates the same public and private key pair according to R to obtain the private key sk. The verifier uses the private key sk to decrypt the received message and obtain the ch value and the identity information of the verifier:

ch+authenticator=decrypt(m,sk).

The verifier first checks whether the hash value of ch is the same as the hash value sent to it. If the hash value is the same, the authentication of the authenticator is completed. After that, the verifier signs ch with the private key sk and sends this message to the verifier.

Step 6. After receiving the signature, the authenticator uses the public key pk to decrypt it, if it is the same as the previous ch value, the whole two-way authentication process is completed.

### Example 2

The authentication process of the symmetric key method is shown in FIG. 4, where the channel of the registration process is considered secure:

Step 1: The authenticator sends the registration request to the verifier.

Step 2: After receiving the registration request, the verifier uses the fuzzy extractor to generate the symmetric key K and help string P. The specific process is as follows:

After receiving the registration request from the authenticator, the verifier first needs to obtain the output result of the RF fingerprint and quantize it. In this embodiment, 512-dimensional RF fingerprint output is adopted, and the output of each dimension is in the range of Dₘᵢₙ˜Dₘₐₓ. We can quantize each dimension, for example, on a scale from 0 to 16, as follows:

$$\\ {D}_{quatization} = [ 16 \times \frac{D - {D}_{min}}{{D}_{max} - {D}_{min}} ] .$$

In addition, because the fuzzy extractor used is distinguished by the Hamming distance of the input, the data obtained above cannot be directly used and needs to be specially processed. Take the number 2 obtained as an example, convert it into the data format 0000 0000 0000 0011, that is, in a total of 16 bits of binary data, there are as many l's as the original data. Finally, the binary data obtained from each dimension were concatenated to obtain the final fingerprint data w. For the processed fingerprint data w, we process it as the input of the fuzzy extractor and execute the generating function:

R,P=Generate(w),

wherein R is a secret value and some algorithm can be used to generate a symmetric key K. P is a help value that is used as input in the reproduction function to output the same R value along with the fingerprint data. Here, the verifier first needs to store the verifier information and the corresponding p-value, and then returns the key K to the verifier.

Step 3: After the authenticator receives the key K, it stores the corresponding key and completes the registration process.

Step 4: The authenticator initiates the authentication request as follows:

The authenticator first utilizes the random number generation function to obtain a challenge value ch. At the same time, the verifier looks for the key K related to the verifier in its own node and sends the encrypted message to the other party, the specific content of the message is as follows:

m=encrypt(ch,K)+authenticator+hash(ch).

Step 5: After receiving the authentication request, the verifier uses the fuzzy extractor to execute the regeneration algorithm to obtain the same R value as the registration phase and recover the key. The specific process is as follows:

After receiving the message from the authenticator, the verifier looks for the P associated with the authenticator in its own node, and at the same time gets the output result of the RF fingerprint and quantifies it as in the registration phase. The verifier takes the fingerprint data w′ and P as the input of the fuzzy extractor and performs the reproduction algorithm to obtain the same R as in the registration phase:

R=Reproduce(w′,P).

The verifier generates the same symmetric key according to R, namely key K. The verifier uses the key K to decrypt the received message and obtain the ch value and the identity information of the verifier:

ch+authenticator=decrypt(m,sk).

The verifier first checks whether the hash value of ch is the same as the hash value sent to it. If the hash value is the same, the authentication of the authenticator is completed. After that, the verifier uses the key K to generate a hash value for ch and sends this message to the authenticator.

Step 6. After receiving the reply message, the authenticator uses the key K to decrypt it, if it is the same as the previous ch value, the whole two-way authentication process is completed.

The present invention realizes the terminal security and privacy authentication based on RF fingerprint through the fuzzy extractor. In this process, the verifier does not need to store the user's characteristic information, so as to form an efficient and reliable mutual authentication protocol.

We claim:

1. A method for implementing bidirectional authentication based on RF fingerprint and fuzzy extractor using two types of nodes denoted by an authenticator and a verifier, respectively, comprising
(1) in a registration phase, sending a registration request from a radio frequency (RF) fingerprint based authenticator to a verifier,
extracting an RF fingerprint feature based on the registration request, processing the RF fingerprint feature through a fuzzy extractor, and generating a help string P related to the authenticator and a string R used for generating a key in the verifier,
storing the help string P in the verifier and sending the string R from the verifier to the authenticator, and storing the string R in the authenticator; and
(2) in an authentication phase, using a random number generation function to generate a challenge value ch and using the key generated by the string R to encrypt a message in the authenticator, and sending the message from the authenticator to the verifier,
using the RF fingerprint features and the help string P obtained in the registration phase to recover the same string R as the registration phase and the string R used for generating the key through the fuzzy extractor in the verifier, generating the key needed for decryption by using the string R, decrypting the message received, and returning a reply message from the verifier to the authenticator,
verifying the reply message by the authenticator, and authenticating an identity of the verifier after passing the verification, and completing a process of mutual authentication.

2. The method of claim 1, wherein the key generated by string R is an asymmetric key prepared by the following steps:
(1) in the registration phase, conducting a quantitative processing by the verifier to obtain a fingerprint data w after receiving the registration request sent by the authenticator and extracting the RF fingerprint features,
using the fingerprint data w as an input for the fuzzy extractor and executing a generation function:
R,P=Generate(w),
wherein the string R is used to generate a public-private key pair of the asymmetric key comprising a public key pk and a private key sk, P is the help string related to the authenticator and used as an input for the generation function and outputs a same string R value together with the fingerprint data w,
storing in the verifier the help string P corresponding to the authenticator's information and returning the public key pk to the authenticator,
corresponding the verifier to the public key pk and storing the public key pk in the authenticator;
(2) in the authentication phase, using a random number generation function to obtain a challenge value ch in the authenticator,
searching the public key pk related to the verifier by the authenticator within authenticator's own node, encrypting the challenge ch value using the public key pk, and sending an encrypted message to the corresponding verifier with the following content:
m=encrypt(ch,pk)+authenticator+hash(ch),
searching for the help string P related to the authenticator in the verifier within the verifier's own node, and quantifying the RF fingerprint features obtained in the registration phase to obtain a fingerprint data w′,
using the fingerprint data w′ and P as input to the fuzzy extractor, and executing a regeneration algorithm to recover the same string R as in the registration phase:
R=Reproduce(w′,P),
generating by the verifier the same public and private key pair based on the string R comprising the private key sk, and using the private key sk to decrypt the received message and obtain a ch value:
ch=decrypt(m,sk),
successfully authenticating the identity of the verifier after the decryption is successful and the hash value is the same,
using the private key sk to sign ch and sending the reply message from the verifier to the authenticator,
using the public key pk to verify the reply message by the authenticator, and
authenticating the identity of the verifier and completing the process of mutual authentication by the authenticator.

3. The method of claim 1, wherein the key generated by the string R is a symmetric key prepared by the following steps:
(1) in the registration phase, after receiving the registration request from the authenticator, the verifier extracting the RF fingerprint features and quantifying the extracted RF fingerprint features to obtain a fingerprint data w, using the fingerprint data w as an input of the fuzzy extractor and executing a generation function as follows:
R,P=Generate(w),
wherein the string R is used to generate a symmetric key K, P is the help string related to the authenticator and used as an input of the generation function and outputs the same string R value together with the fingerprint data w,
the verifier storing the help string P corresponding to the authenticator's information and returning the symmetric key K to the authenticator,
corresponding the verifier with the symmetric key K and storing the symmetric K by the authenticator; and
(2) in the authentication phase, using a random number generation function to obtain a challenge value ch by the authenticator,
the authenticator looking up the symmetric key K corresponding to the verifier in the authenticator's own node, encrypting the challenge ch value with the symmetric key K, and sends an authentication request to the corresponding verifier with the following content:
m=encrypt(ch,K)+authenticator+hash(ch),
the verifier searching for the help string P related to the authenticator in the verifier's own node, and quantizing the RF fingerprint features obtained in the registration phase to obtain a fingerprint data w′,
using the fingerprint data w′ and P as input to the fuzzy extractor, and executing a regeneration algorithm to recover the same string R as in the registration phase:
R=Reproduce(w′,P),
the verifier generating the same symmetric key K according to the string R, and using the symmetric key K to decrypt the received message and obtain a ch value:
ch=decrypt(m,K),
the authenticator successfully authenticating the identity of the verifier after the hash value is successfully decrypted and verified,
the verifier using the symmetric key K to sign the ch and sending the reply message to the authenticator,
after receiving the reply message, the authenticator using the symmetric key K to verify, and the verifier authenticating the identity of the authenticator after the verification passes, and completing the process of mutual authentication.
